(19) United States
(12) Patent Application Publication
(10) Pub. No.: US 2023/0150068 A1
(43) Pub. Date: May 18, 2023

(54) LASER NOTCING MACHINE SCRAP DRAlNAGE CONVEYOR AND SCRAP DRAlNAGE METHOD

(71) Applicant: MPLUS CORP., Cheongun-si, Chuncheongbuk-do (KR)

(72) Inventors: Jong Sung KIM, Seongnam-si (KR); Kang Ho KO, Yongin-si (KR); Seong Moon KIM, Cheongju-si (KR)

(73) Assignee: MPLUS CORP., Cheongun-si, Chuncheongbuk-do (KR)

(21) Appl. No.: 17/919,758

(22) PCT Filed: Apr. 13, 2021
(86) PCT No.: PCT/KR2021/004619

§ 371 Date: Oct. 19, 2022

(30) Foreign Application Priority Data
Apr. 20, 2020 (KR) 10-2020-0047438

(51) Int. Cl. B23K 26/70; B23K 26/38; B23K 26/142

(52) U.S. Cl. CPC B23K 26/702; B23K 26/38; B23K 26/142; B23K 2101/36

(57) ABSTRACT

The objective of the present invention is to provide a conveyor for discharging scraps of a laser notching machine. The present invention comprises: a conveyor (20); a suction duct (52) which is connected to the conveyor (20) so as to suck, from the conveyor, scraps (2S) generated when a tab (2C) is formed on a pole plate (2) passing through the conveyor (20); and a scrap discharge hole (34) for sucking and discharging the scraps (2S) from the conveyor (20), wherein the conveyor (20) includes: a conveyor body (22); and a conveyor belt (24) for performing a continuous track motion so as to pass the upper and lower surfaces of the conveyor body (22), wherein the conveyor body (22) has a vacuum sector (22VS) and a vacuum release sector (22RS), the vacuum sector (22VS) is configured to have a vacuum suction hole communicating from the inner space portion of the conveyor body (22) to the bottom surface of the conveyor body (22), and the scrap discharge hole (34) is disposed under the vacuum release sector (22RS).

### TECHNICAL FIELD

The present disclosure relates generally to a conveyor for discharging scrap of a laser notching machine and a scrap discharge method thereof. More particularly, the present disclosure relates to a conveyor for discharging scrap of a laser notching machine and a scrap discharge method thereof, the conveyor having a new configuration capable of efficiently discharging scrap resulting from forming a tab by laser notching during continuous transfer of an electrode plate.

### BACKGROUND ART

A secondary battery is generally manufactured by stacking a plurality of separators between a plurality of positive and negative electrode plates. In the manufacturing process of secondary batteries, a secondary battery is manufactured using a reel electrode plate (a continuous electrode plate, hereinafter referred to as an electrode plate for convenience) wound in a roll form on one winding roll. The electrode plate is formed by coating an active material on a thin aluminum or copper foil, and has an active material coated portion and at one end thereof, an uncoated portion exposed without an active material coating. An operation such as forming a tab through notching processing is performed while winding the electrode plate wound on one unwinding roll in a roll form on the other winding roll. The secondary battery is manufactured in such a manner that a process of forming the tab (notching process) is performed while the electrode plate, which has on each surface thereof, the active material coated portion 2A coated with the active material and at one end thereof (upper or lower end), the uncoated portion exposed without the active material coating, is transferred along a transfer line, and then a separator is interposed between the positive and negative electrode plates by winding the electrode plate with the tab formed, or the separator is interposed and stacked between the positive and negative electrode plates by cutting the electrode plate is cut into a predetermined area. In the manufacture of the secondary battery, there is a notching process (cutting process) in which a tab is formed in an uncoated portion of an electrode plate by cutting out scrap from the electrode plate using a laser notching machine.

Meanwhile, the remaining part resulting from forming a plurality of tabs at regular intervals in the electrode plate with a laser becomes scrap. The strip-shaped scrap is discharged to the outside.

As illustrated in FIG. 1, in a conventional scrap discharging method, a stand 110 is installed under an electrode plate 2, and a slit 112 for a laser path and a scrap discharge hole 114 are formed in the stand 110. A plurality of tabs 2C are formed at regular intervals in an uncoated portion 2B of the electrode plate 2 as a laser moves along the slit 112 for the laser path, and the scrap discharge hole 114 sucks and discharges scrap 2S by air suction.

When the electrode plate 2 continuously passes along a transfer path, the uncoated portion of the electrode plate 2 is cut with the laser emitting from a laser notching machine, thereby forming the tabs 2C at regular intervals in the electrode plate 2. The tabs 2C are formed at regular intervals in the uncoated portion of the electrode plate 2 by partially laser-cutting the uncoated portion and a coated portion of the electrode plate 2 while continuously transferring the electrode plate 2. The formation of the tabs 2C using the laser notching machine while continuously moving the electrode plate 2 is achieved by a laser cutting process (laser notching process), which will be described as follows.

The process of cutting the electrode plate 2 by the laser of the laser notching machine while transferring it at a constant speed is classified into an entry cutting process, a coated portion cutting process, and an exit cutting process (see FIG. 3).

In the entry cutting process, the laser cuts a part of each of the uncoated portion 2B and the coated portion of the electrode plate 2 while moving obliquely in the transfer direction of the electrode plate 2. Since the electrode plate 2 moves at a constant speed and the laser cuts the electrode plate 2 while moving obliquely in the transfer direction of the electrode plate 2, the uncoated portion 2B of the electrode plate 2 is cut in a right angle direction at an entry portion of the electrode plate 2. When the electrode plate 2 moves at a constant speed and the laser cuts the electrode plate 2 while moving obliquely in the transfer direction of the electrode plate 2, the angle of the relative speed of the laser with respect to the electrode plate 2 is 90°, and thus the uncoated portion 2B of the electrode plate 2 is cut at a right angle at the entry portion (see FIG. 4).

In the coated portion cutting process, the electrode plate 2 moves at a constant speed and the laser cuts a part of the coated portion while moving in the opposite direction to the moving direction of the electrode plate 2. The electrode plate 2 and the part of the coated portion are cut in the longitudinal direction of the electrode plate 2 (i.e., the moving direction of the electrode plate 2) (see FIG. 5).

In the exit cutting process, the laser cut a part of each of the uncoated portion 2B and the coated portion of the electrode plate 2 while moving obliquely in the opposite direction to the transfer direction of the electrode plate 2. Since the electrode plate 2 moves at a constant speed and the laser cuts the electrode plate 2 while moving obliquely in the opposite direction to the transfer direction of the electrode plate 2, the uncoated portion 2B of the electrode plate 2 is cut in a right angle direction at an exit portion of the electrode plate 2. When the electrode plate 2 moves at a constant speed and the laser cuts the electrode plate 2 while moving obliquely in the opposite direction to the transfer direction of the electrode plate 2, the angle of the relative speed of the laser with respect to the electrode plate 2 is 90°, and thus the uncoated portion 2B of the electrode plate 2 is cut at a right angle at the exit portion (see FIG. 6).

Consequently, the laser cuts the electrode plate 2 while moving in the first oblique direction D1, the longitudinal direction D2, and the second oblique direction D3 as the electrode plate 2 moves at a constant speed in the transfer direction, whereby the tabs 2C are formed at regular intervals in the uncoated portion 2B of the electrode plate 2 (see FIG. 7).

However, the conventional method has some problems. That is, it is difficult to discharge the scrap, the scrap is often blown over the electrode plate, and the size and position of the scrap discharge hole needs to be adjusted according to the speed of the electrode plate and the size of the scrap due to high sensitivity to the speed of the electrode plate.

In addition, when the scrap suction flow rate is increased, the tab of the electrode plate is sucked into the scrap discharge hole and crumpled. When the tab of the electrode plate is sucked in and crumpled, a defect occurs in the electrode plate, and the tab forming process and the suction process need to be stopped and reset to restart the operation. This is not desirable in terms of work efficiency and productivity.

### DISCLOSURE

### Technical Problem

Accordingly, the present disclosure has been made keeping in mind the above problems occurring in the related art, and an objective of the present disclosure is to provide a conveyor for discharging scrap of a laser notching machine and a scrap discharge method thereof, the conveyor having a new configuration capable of efficiently discharging scrap resulting from forming a tab by laser notching during continuous transfer of an electrode plate.

### Technical Solution

In order to accomplish the above objective, the present disclosure provides a conveyor for discharging scrap of a laser notching machine, the conveyor including: a conveyor; a suction part connected to the conveyor and configured to suck scrap resulting from forming a tab in an electrode plate passing through the conveyor; and a scrap discharge hole configured to suck and discharge the scrap from the conveyor.

### Advantageous Effects

The present disclosure has the following useful effect. That is, it is possible to efficiently discharge scrap resulting from forming a tab in an electrode plate; it is possible to prevent the scrap from being blown over the electrode plate; it possible to eliminate the need to adjust the size and position of a scrap discharge hole according to the speed of the electrode plate and the size of the scrap; and it is possible to prevent the tab of the electrode plate from being sucked into the scrap discharge hole and crumpled.

### DESCRIPTION OF DRAWINGS

FIG. 1 is a perspective view illustrating a conventional scrap discharge method.

FIG. 2 is a sectional view illustrating the conventional scrap discharge method.

FIG. 3 is a plan view conceptually illustrating a laser cutting process of forming a tab in an electrode plate.

FIG. 4 is a view illustrating the laser cutting process performed at an entry portion while moving the electrode plate at a constant speed.

FIG. 5 is a view illustrating the laser cutting process performed in the longitudinal direction of the electrode plate while moving the electrode plate at the constant speed.

FIG. 6 is a view illustrating the laser cutting process performed at an exit portion while moving the electrode plate at the constant speed.

FIG. 7 is a view illustrating a movement path of a laser for forming the tab in the electrode plate moving at the constant speed.

FIG. 8 is a perspective view illustrating a conveyor for discharging scrap of a laser notching machine according to an embodiment of the present disclosure.

FIG. 9 is a front view illustrating a scrap discharge process of the conveyor for discharging scrap of the laser notching machine illustrated in FIG. 8.

FIG. 10 is a bottom view illustrating the scrap discharge process of the conveyor for discharging scrap of the laser notching machine illustrated in FIG. 8.

FIG. 11 is a front view illustrating a scrap discharge process of the conveyor for discharging scrap of the laser notching machine according to the present disclosure in which scrap is discharged through a scrap discharge hole of a scrap discharge duct by air suction.

FIG. 12 is a perspective view illustrating a conveyor for discharging scrap of a laser notching machine according to another embodiment of the present disclosure.

FIG. 13 is a front view illustrating a scrap discharge process the conveyor for discharging scrap of the laser notching machine illustrated in FIG. 12 in which scrap is discharged through a scrap discharge hole of a scrap discharge duct by air suction.

FIG. 14 is a front view illustrating a scrap discharge process of a conveyor for discharging scrap of a laser notching machine according to still another embodiment of present disclosure in which scrap is discharged through a scrap discharge hole of a scrap discharge duct by air suction.

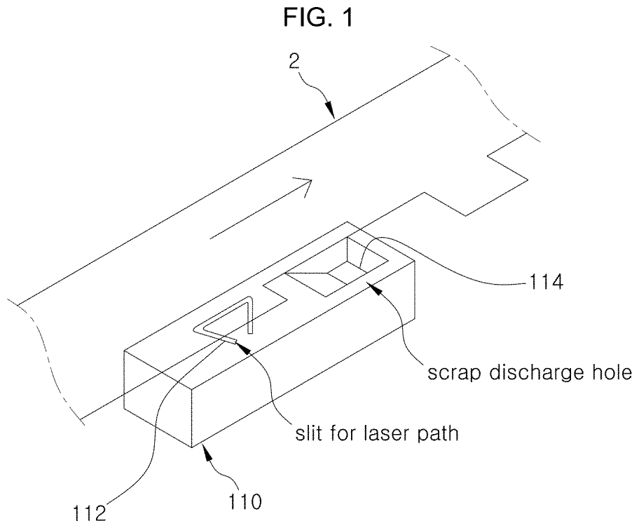

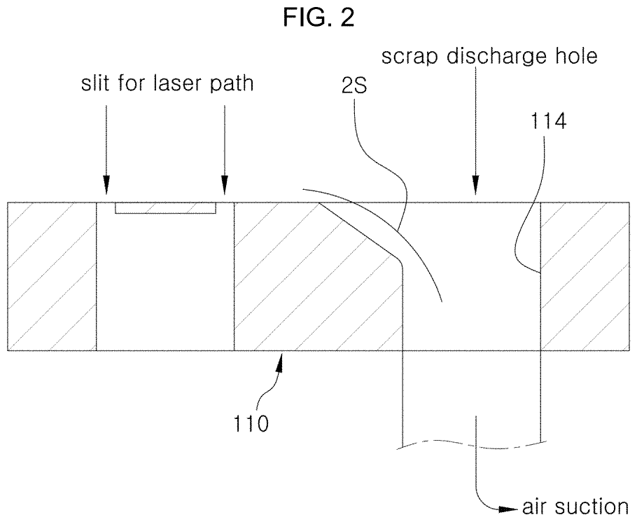

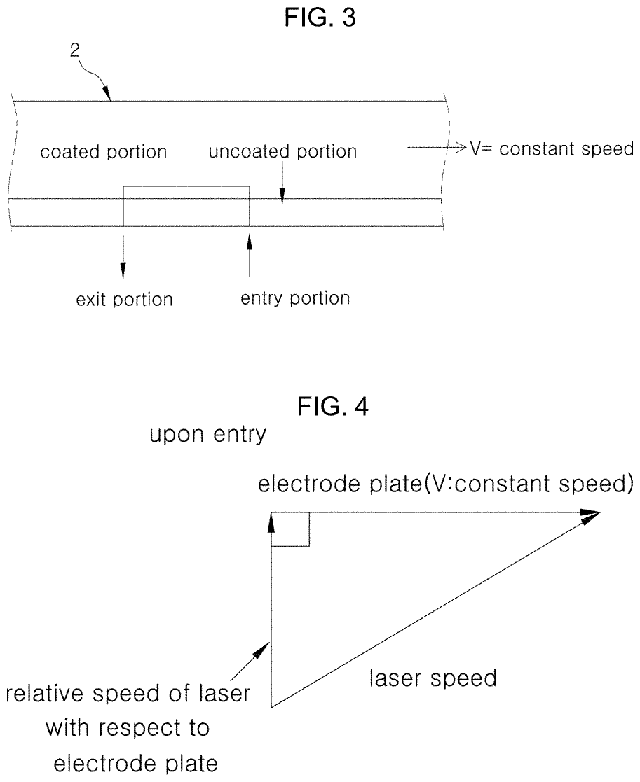

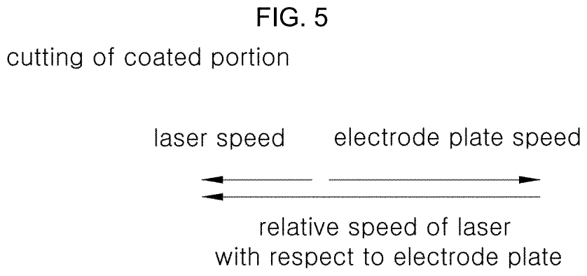

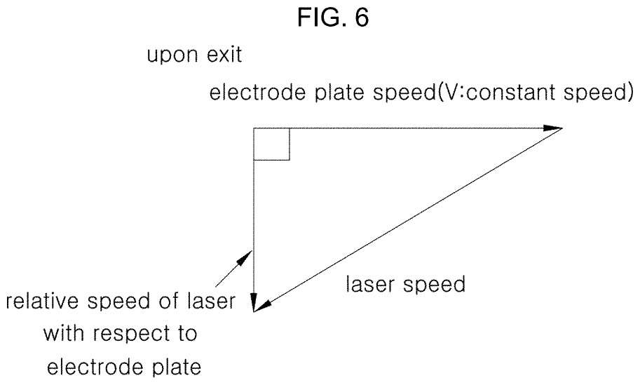

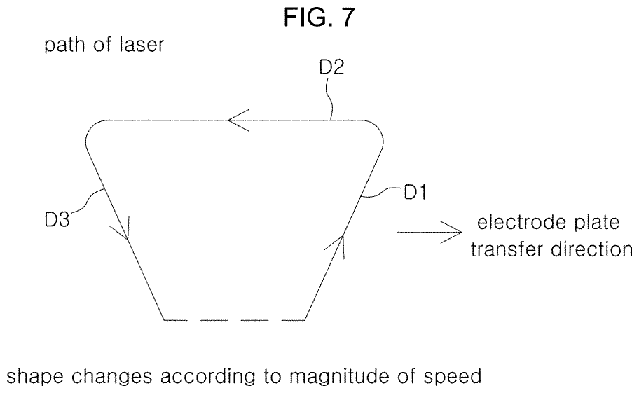

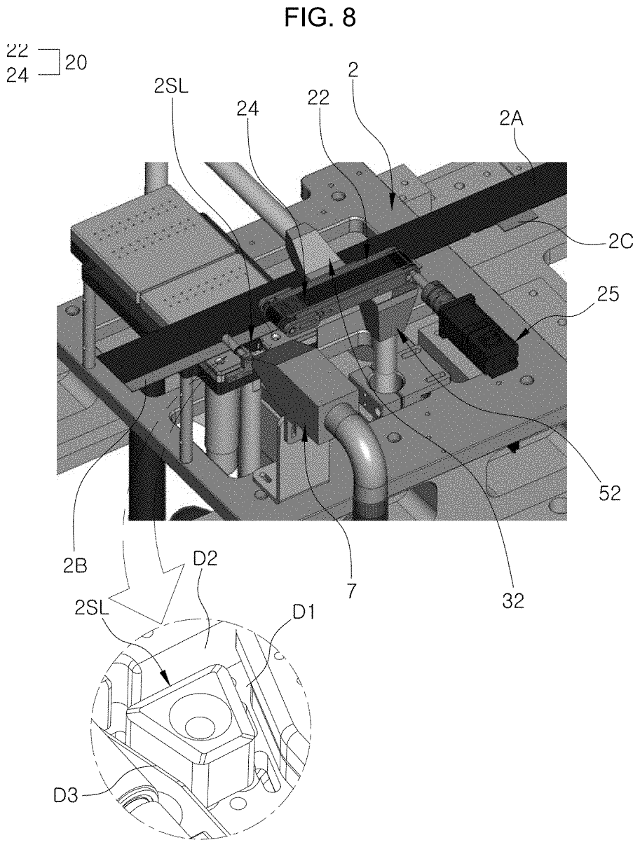

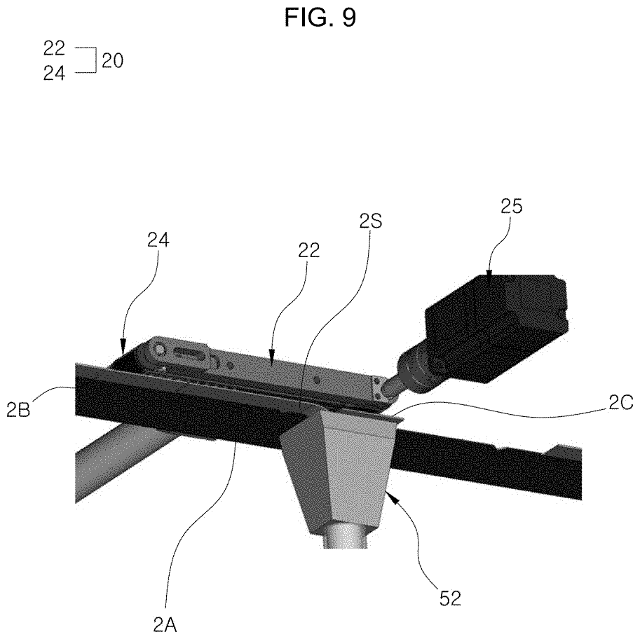

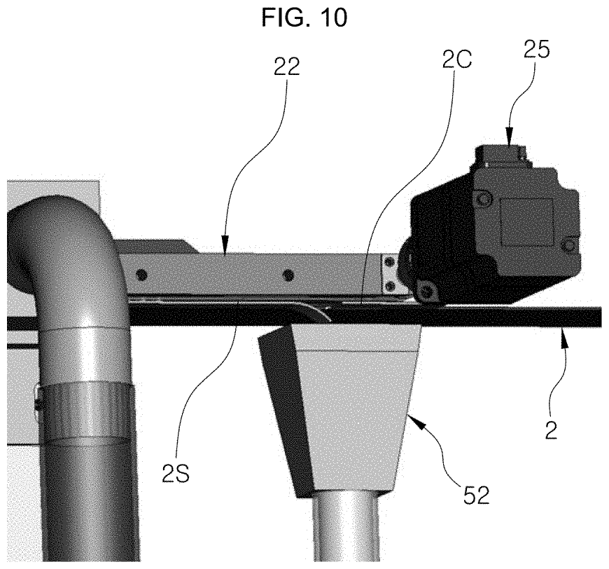

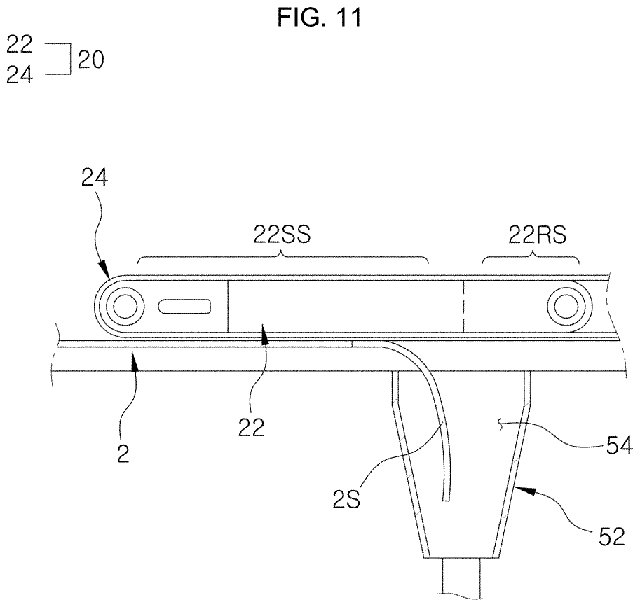

### BEST MODE

The present disclosure relates to a conveyor for discharging scrap of a laser notching machine, the conveyor including: a conveyor; a suction part connected to the conveyor and configured to suck scrap resulting from forming a tab in an electrode plate passing through the conveyor; and a scrap discharge hole configured to suck and discharge the scrap from the conveyor. The conveyor includes: a conveyor body; and a conveyor belt configured to move along a continuous track so as to pass over upper and lower surfaces of the conveyor body, and a vacuum sector is provided in a transfer path through which the electrode plate passes. The vacuum sector is provided with a vacuum hole communicating from an inner space of the conveyor body to the lower surface of the conveyor body, the scrap discharge hole is disposed under the conveyor belt, and the suction part includes a suction duct communicating with the inner space of the conveyor body.

### Mode for Invention

A conveyor for discharging scrap of a laser notching machine according to the present disclosure includes a conveyor 20 disposed such that a reel electrode plate 2 (hereinafter, referred to as an electrode plate for convenience) passes through the conveyor 20 under the conveyor 20, a suction part for sucking scrap 2S resulting from forming a tab 2C in the electrode plate 2, and a scrap discharge hole 34 for sucking and discharging the scrap 2S. In this case, the suction part includes a suction duct 52 communicating with an inner space of a conveyor body 22. The suction part is a means capable of applying a vacuum pressure to the inner space of the conveyor body 22.

The conveyor 20 includes the conveyor body 22 and a conveyor belt 24.

The conveyor body 22 is configured in a rectangular plate shape. The conveyor body 22 is disposed above the electrode plate 2 passing along a transfer line. The conveyor body 22 is configured in a plate shape having a space therein. A vacuum sector 22VS and a vacuum release sector 22RS are provided along the transfer path through which the electrode plate 2 passes. The conveyor body 22 may be configured to include the vacuum sector 22VS and the vacuum release sector 22RS so that the vacuum sector 22VS and the vacuum release sector 22RS are provided along the transfer path of the electrode plate 2. The vacuum sector 22VS and the vacuum release sector 22RS may be configured to be partitioned by a diaphragm provided inside the conveyor body 22. The vacuum sector 22VS is configured to have a plurality of vacuum holes communicating from the inner space of the conveyor body 22 to a lower surface of the conveyor body 22. The vacuum release sector 22RS has no vacuum hole.

The conveyor belt 24 moves along a continuous track so as to pass over upper and lower surfaces of the conveyor body 22. A pair of rollers 23 are provided at portions adjacent to an electrode plate inlet end and an electrode plate outlet end of the conveyor body 22, respectively. The roller 23 installed adjacent to the electrode plate outlet end is connected to a motor shaft of a servomotor 25 for conveyor driving. The conveyor belt 24 is coupled to the pair of rollers 23 and disposed on the upper and lower surfaces of the conveyor body 22. As the motor shaft of the servomotor 25 rotates, the conveyor belt 24 moves along a continuous track so as to pass over the upper and lower surfaces of the conveyor body 22. The conveyor belt 24 is provided with a plurality of vacuum suction holes formed through opposite surfaces thereof. When vacuum pressure is applied to the space in which the vacuum holes of the conveyor body 22 are formed, a vacuum pressure capable of adsorbing the scrap 2S resulting from forming the tab 2C of the electrode plate 2 is applied to the vacuum suction holes of the conveyor belt 24 through the vacuum holes. In this case, the scrap discharge hole 34 is disposed under the conveyor belt 24. The scrap 2S adsorbed to the conveyor belt 24 is sucked into and discharged through the scrap discharge hole 34 by air suction pressure.

The electrode plate 2 has a coated portion 2A and an uncoated portion 2B. A part of each of the conveyor body 22 and the conveyor belt 24 is disposed above the uncoated portion 2B of the electrode plate 2 passing thereunder.

The suction duct 52 is connected to the conveyor body 22. In other words, the suction duct 52 is connected to an inner space of the vacuum sector 22VS of the conveyor body 22. The suction duct 52 is connected to a vacuum device (not illustrated). Vacuum pressure generated in the vacuum device is applied to the inner space of the vacuum sector 22VS of the conveyor body 22 through the suction duct 52. When the vacuum pressure is applied to the inner space of the vacuum sector 22VS, the vacuum pressure is applied to a lower surface of the conveyor belt 24 through the plurality of vacuum holes and the plurality of vacuum suction holes of the conveyor belt 24. When the vacuum pressure is applied to the lower surface of the conveyor belt 24 passing over the lower surface of the conveyor body 22, the scrap 2S resulting from forming the tab 2C in the uncoated portion 2B of the electrode plate 2 is adsorbed to the lower surface of the conveyor belt 24 by the vacuum pressure. In other words, the suction duct 52 allows the conveyor 20 to suck the scrap 2S resulting from forming the tab 2C in the electrode plate 2 passing through the conveyor 20 by the vacuum pressure. Specifically, the scrap 2S is sucked and adsorbed in the vacuum sector 22VS of the conveyor 20. Since the scrap 2S is sucked in the vacuum sector 22VS of the conveyor body 22 by the vacuum pressure so as to be adsorbed on the lower surface of the conveyor belt 24, it can be said that the scrap 2S is sucked in the vacuum sector 22VS of the conveyor 20.

A scrap discharge duct 32 is provided under the vacuum release sector 22RS of the conveyor body 22. The scrap discharge hole 34 is provided inside the scrap discharge duct 32. An air suction device (not illustrated) is connected to the scrap discharge duct 32, so that an air pressure capable of sucking the scrap 2S is applied to the scrap discharge hole 34 inside the scrap discharge duct 32 by the air suction device.

Meanwhile, the present disclosure provides a scrap discharge method of a conveyor for a laser notching machine, the method including a scrap suction step of sucking scrap 2S, which results from forming a tab 2C in an electrode plate 2 passing through a conveyor 20, in a vacuum sector 22VS of the conveyor 20 by vacuum pressure so as to be adsorbed to a lower portion of the conveyor 20, a scrap transfer step of transferring the scrap 2S to a vacuum release sector 22RS of the conveyor 20, and a scrap discharge step of sucking the scrap 2S into the scrap discharge hole 34 under the vacuum release sector 22RS and discharging the scrap 2S.

In the scrap suction step, the scrap 2S remaining after forming the tab 2C in the electrode plate 2 is sucked in the vacuum sector 22VS of the conveyor body 22 by vacuum pressure so as to be adsorbed to a conveyor belt 24 passing over a lower surface of the conveyor body 22.

In the scrap transfer step, the scrap 2S is transferred to the vacuum release sector 22SS of the conveyor 20. In the scrap discharge step, the scarp 2S is sucked into the scrap discharge hole 34 under the vacuum release sector 22RS and discharged by air suction in a state in which the vacuum pressure is released in the vacuum release sector 22RS.

According to the present disclosure having the above configuration, a plurality of tabs 2C are formed at regular intervals in the uncoated portion 2B of the electrode plate 2 while a laser moves along a laser slit 2SL. In other words, the laser cuts the electrode plate 2 while moving in the first oblique direction D1, the longitudinal direction D2, and the second oblique direction D3 as the electrode plate 2 moves at a constant speed in the transfer direction, whereby the tabs 2C are formed at regular intervals in the uncoated portion 2B of the electrode plate 2. A fume exhaust duct 7 is provided adjacent to the laser slit 2SL. The fume exhaust duct 7 sucks and discharges foreign substances resulting from laser cutting of the tabs 2C in the electrode plate 2.

The scrap 2S resulting from forming the tabs 2C in the electrode plate 2 is discharged through the scrap discharge hole 34 provided in the scrap discharge duct 32. In other words, the scrap 2S resulting from forming the tab 2C in the electrode plate 2 is sucked in the vacuum sector 22VS of the conveyor body 22 by vacuum pressure so as to be adsorbed to the conveyor belt 24 passing over the lower surface of the conveyor body 22, and then the scrap 2S is sucked into the scrap discharge hole 34 under the vacuum release sector 22RS by air suction in a state in which the vacuum pressure is released in the vacuum release sector 22RS.

The scrap discharge duct 32 is disposed under the vacuum release sector 22RS of the conveyor 20 (precisely, the vacuum release sector 22RS of the conveyor body 22), so that when the scrap 2S that has passed the vacuum sector 22VS of the conveyor 20 enters the vacuum release sector 22RS, the vacuum acting on the scrap 2S is released. Thus, the scrap 2S resulting from forming the tabs 2C in the electrode plate 2 is separated from the conveyor belt 24 downwards, and when the scrap 2S may pass above the scrap discharge duct 32, a suction force (e.g., air suction pressure) is applied to the scrap discharge hole 34 to cause the scrap 2S released from the conveyor belt 24 to be sucked downwards into the scrap discharge hole 34 and discharged to the outside through the scrap discharge duct 32.

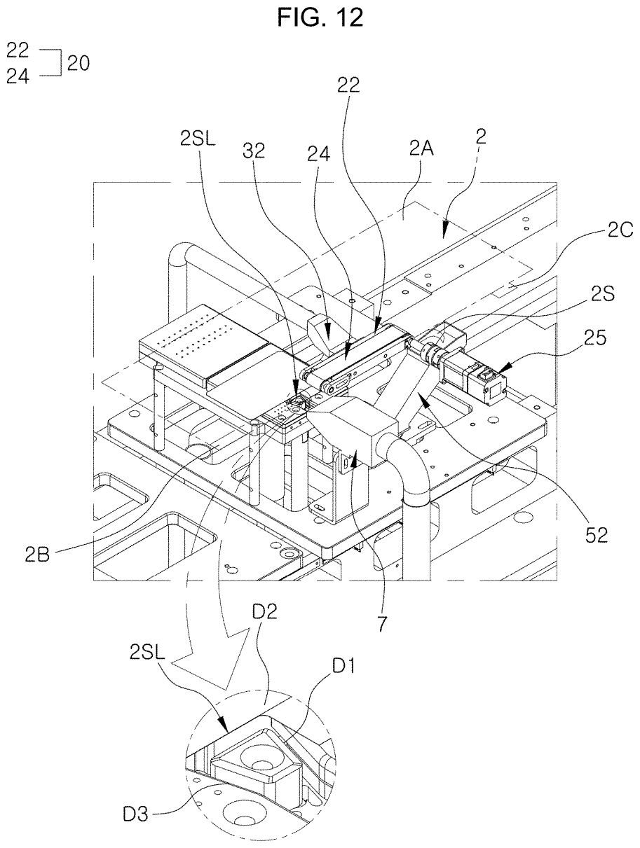

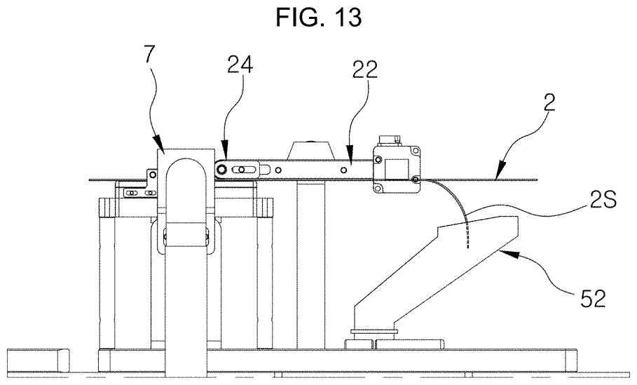

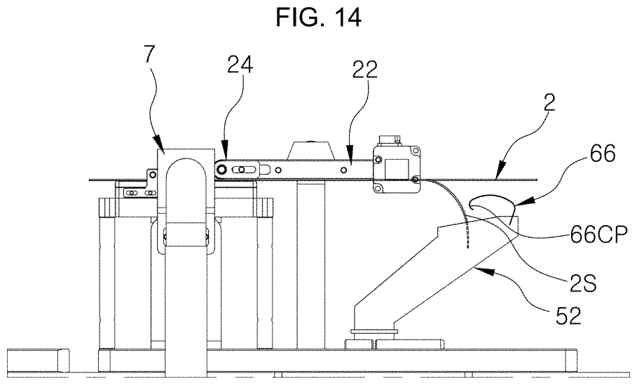

On the other hand, the scrap discharge duct 32 may be provided at a position outside the electrode plate outlet end of the conveyor body 22 so that the scrap discharge hole 34 is provided next to the electrode plate outlet end of the conveyor body 22. In this case, provision of the diaphragm in the inner space of the conveyor body 22 is omitted, the suction duct 32 is connected to the inner space of the conveyor body 22 so that the entire inner space of the conveyor body 22 forms the vacuum sector 22VS, and the vacuum suction holes are formed in the entire lower surface of the conveyor body 22. Thereby, the vacuum is automatically released at the position past the electrode plate outlet end of the conveyor body 22 (i.e., the position where the electrode plate 2 and the scrap 2S have passed the vacuum sector 22VS), so that when the scrap 2S resulting from forming the tabs 2C in the electrode plate 2 enters the position past the electrode plate outlet end of the conveyor body 22, the scrap 2S is sucked into the scrap discharge hole 34 by the air suction pressure acting on the scrap discharge hole 34 inside the scrap discharge duct 32 and discharged (see FIGS. 12 and 13).

Here, the present disclosure is configured such that the air suction pressure acting on the scrap discharge hole 34 is stopped when the tabs 2C formed in the electrode plate 2 pass the scrap discharge hole 34. In other words, after the scrap 2S is sucked into and discharged through the scrap discharge hole 34 by the air suction pressure, the tabs 2C of the electrode plate 2 pass above the scrap discharge hole 34. At this time, the air suction pressure acting on the scrap discharge hole 34 is released. The release of the air suction pressure may be achieved by stopping the operation of the air suction device (not illustrated) connected to the scrap discharge hole 34 when the tabs 2C of the electrode plate 2 pass above the scrap discharge hole 34.

The characteristics of the conveyor for discharging scrap according to the present disclosure are summarized as follows.

The present disclosure is controlled by the servomotor 25, so that the transfer speed of the electrode plate 2 and the rotation speed of the conveyor belt 24 are the same.

The vacuum suction holes (i.e., the vacuum suction holes) are provided in the conveyor belt 24.

The scrap 2S cut out by the laser is adsorbed to the lower portion of the conveyor belt 24 of the conveyor 20 and transferred rearwards. The scrap 2S being transferred rearwards means that the scrap 2S is transferred to the vacuum release sector 22RS of the conveyor 20.

The suction force is removed at the position above the scrap discharge hole 34, so that the scrap 2S is separated from the conveyor belt 24. As the suction force is released in the vacuum release sector 22RS of the conveyor 20, the scrap 2S becomes separable from the conveyor belt 24.

The scrap 2S is discharged through the scrap discharge hole 34 by air suction. In other words, in a state in which the vacuum pressure holding the scrap 2S on the lower surface of the conveyor belt 24 in the vacuum release sector 22RS of the conveyor 20 is released, the scrap 2S is discharged through the scrap discharge hole 34 inside the scrap discharge duct 32 by air suction.

Therefore, in the present disclosure, it is possible to efficiently discharge the scrap 2S, it is possible to prevent the scrap 2S from being blown over the electrode plate 2, and low sensitivity to the speed of the electrode plate 2 makes it possible to eliminate the need to adjust the size and position of the scrap discharge hole 34 according to the speed of the electrode plate 2 and the size of the scrap 2S.

Furthermore, in the present disclosure, the air suction pressure acting on the scrap discharge hole 34 is stopped when the tabs 2C formed in the electrode plate 2 pass the scrap discharge hole 34. This prevents the tabs 2C of the electrode plate 2 from being sucked into the scrap discharge hole 34 and crumpled.

By preventing the tabs 2C of the electrode plate 2 from being sucked in and crumpled, it is possible to prevent a defect from occurring in the electrode plate 2, and there is no need to stop and reset the tab forming process and the suction process to restart the operation. This is very advantageous in terms of work efficiency and productivity.

Meanwhile, in the present disclosure, a guide shield 66 may be further provided above the scrap discharge hole 34. The guide shield 66 may be supported by the scrap discharge duct 32 through a connection piece connected to the scrap discharge duct 32 or may be supported by another support such as a bracket so that the guide shield 66 is located above the scrap discharge hole 34. Preferably, the guide shield 66 is configured as a curved plate and a front end of the guide shield 66 is spaced a predetermined distance from a front inner surface of the scrap discharge duct 32 so that a sufficient suction space for the scrap 2S to be sucked in is secured between the front end of the guide shield 66 and the front inner surface of the scrap discharge duct 32.

Therefore, when the tabs 2C formed in the electrode plate 2 pass above the guide shield 66, the guide shield 66 blocks the air suction pressure acting on the scrap discharge hole 34, thereby preventing the tabs 2C from being sucked into the scrap discharge hole 34 by the air suction pressure. At the same time, the scrap 2S is efficiently sucked into and discharged through the suction space secured between the front end of the guide shield 66 and the front inner surface of the scrap discharge duct 32, so it is possible to prevent the tabs 2C of the electrode plate 2 from being crumpled during transfer. Preferably, a downwardly extending curved guide plate 66CP is provided at the front end of the guide shield 66, so that when the electrode plate 2 and the tabs 2C pass, the tabs 2C are guided by the curved guide plate 66CP so as to pass above the guide shield 66 more reliably without being caught by the front end of the guide shield 66, and the scrap 2S of the electrode plate 2 is more reliably sucked into the scrap discharge hole 34 inside the scrap discharge duct 32 by the curved guide plate 66CP.

### INDUSTRIAL APPLICABILITY

A conveyor for discharging scrap of a laser notching machine according to the present disclosure includes: a conveyor; a suction part connected to the conveyor and configured to suck scrap resulting from forming a tab in an electrode plate passing through the conveyor; and a scrap discharge hole configured to suck and discharge the scrap from the conveyor. The conveyor according to the present disclosure has industrial applicability as a conveyor for use in discharging scrap of a laser notching machine.

1. A conveyor for discharging scrap of a laser notching machine, the conveyor comprising:
a conveyor (20);
a suction part connected to the conveyor (20) and configured to suck scrap (2S) resulting from forming a tab (2C) in an electrode plate (2) passing through the conveyor (20); and
a scrap discharge hole (34) configured to suck and discharge the scrap (2S) from the conveyor (20).

2. The conveyor of claim 1, wherein the conveyor (20) comprises:
a conveyor body (22); and
a conveyor belt (24) configured to move along a continuous track so as to pass over upper and lower surfaces of the conveyor body (22), and
a vacuum sector (22VS) is provided in a transfer path through which the electrode plate (2) passes,
wherein the vacuum sector (22VS) is provided with a vacuum hole communicating from an inner space of the conveyor body (22) to the lower surface of the conveyor body (22),
the scrap discharge hole (34) is disposed under the conveyor belt (244), and
the suction part comprises a suction duct (52) communicating with the inner space of the conveyor body (22).

3. The conveyor of claim 2, wherein the vacuum sector (22VS) of the conveyor body (22) is provided with a plurality of vacuum holes communicating from the inner space to the lower surface of the conveyor body (22), and the conveyor belt (24) is provided with a plurality of vacuum suction holes communicating with the vacuum holes, so that the scrap (2S) resulting from forming the tab (2C) in the electrode plate (2) is sucked in the vacuum sector (22VS) of the conveyor body (22) so as to be adsorbed to the conveyor belt (24) passing over the lower surface of the conveyor body (22) by vacuum pressure, and the scrap (2S) is sucked into and discharged through the scrap discharge hole (34) as the vacuum pressure is automatically released at a position where the electrode plate (2) and the scrap (2S) have passed the vacuum sector (2VS).

4. The conveyor of claim 3, wherein a scarp discharge duct (32) is provided below the position where the scrap (2S) has passed through the vacuum sector (22VS), and the scrap discharge hole (34) is provided inside the scrap discharge duct (32).

5. The conveyor of claim 1, further comprising a guide shield (66) provided above the scrap discharge hole (34) so that the tab (2C) formed in the electrode plate (2) passes above the guide shield (66).

6. A scrap discharge method of a conveyor for a laser notching machine, the method comprising:
a scrap suction step of sucking scrap (2S), which results from forming a tab (2C) in an electrode plate (2) passing through a conveyor (20), in a vacuum sector (22VS) of the conveyor (20) by vacuum pressure so as to be adsorbed to a lower portion of the conveyor (20);
a scrap transfer step of transferring the scrap (2S) to a vacuum release sector (22RS) of the conveyor (20); and
a scrap discharge step of sucking the scrap (2S) into the scrap discharge hole (34) under the vacuum release sector (22RS) and discharging the scrap (2S).

7. The method of claim 6, wherein the conveyor (20) comprises a conveyor belt (24) configured to move along a continuous track so as to pass over upper and lower surfaces of a conveyor body (22), the vacuum sector (22VS) of the conveyor body (22) is provided with a plurality of vacuum holes communicating from an inner space of the conveyor body (22) to the lower surface of the conveyor body (22), and the conveyor belt (24) is provided with a plurality of vacuum suction holes communicating with the vacuum holes, so that the scrap (2S) resulting from forming the tab (2C) in the electrode plate (2) is sucked in the vacuum sector (22VS) of the conveyor body (22) so as to be adsorbed to the conveyor belt (24) passing over the lower surface of the conveyor body (22) by vacuum pressure, and the scrap (2S) is sucked into and discharged through the scrap discharge hole (34) as the vacuum pressure is released in the vacuum release sector (22RS).
